(19) United States
(12) Patent Application Publication
(10) Pub. No.: US 2018/0057385 A1
(43) Pub. Date: Mar. 1, 2018

(54) Portable Assembly For Extracting Water From Air

(71) Applicant: Dana Bray, III, Huntington Beach, CA (US)

(72) Inventor: Dana Bray, III, Huntington Beach, CA (US)

(21) Appl. No.: 15/249,812

(22) Filed: Aug. 29, 2016

(51) Int. Cl. C02F 9/00; F24F 5/00; F24F 13/22; B01D 5/00; A45F 3/04

(52) U.S. Cl. CPC C02F 9/005; F24F 5/001; F24F 13/222; B01D 5/0006; A45F 3/04; A45F 2003/003; F24F 2013/228; F24F 2005/0067; C02F 2201/009; C02F 2201/008; F24F 2221/12

(57) ABSTRACT

A portable assembly for extracting water from air for provision of potable water includes a housing that defines an internal space. The housing is vented. A plurality of grasps is coupled to the housing. A power module, a condensing unit and a reservoir are coupled to the housing and positioned in the internal space. The condensing unit is operationally coupled to the power module. The reservoir is positioned below the condensing unit and is fluidically coupled to the condensing unit. The grasps are configured to couple to a user, such that the housing is coupled to the user for transport. An evaporator coil of the condensing unit is configured to contact air that enters the internal space. Water vapor in the air condenses on the evaporator coil and falls to a bottom of the condensing unit. Liquid water that is positioned on the bottom of the condensing unit flows to and is collected in the reservoir.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to assemblies for water production and more particularly pertains to a new water production assembly for provision of potable water.

### BRIEF SUMMARY OF THE INVENTION

An embodiment of the disclosure meets the needs presented above by generally comprising a housing that defines an internal space. The housing is vented. A plurality of grasps is coupled to the housing. A power module, a condensing unit and a reservoir are coupled to the housing and positioned in the internal space. The condensing unit is operationally coupled to the power module. The reservoir is positioned below the condensing unit and is fluidically coupled to the condensing unit. The grasps are configured to couple to a user, such that the housing is coupled to the user for transport. An evaporator coil of the condensing unit is configured to contact air that enters the internal space. Water vapor in the air condenses on the evaporator coil and falls to a bottom of the condensing unit. Liquid water that is positioned on the bottom of the condensing unit flows to and is collected in the reservoir.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a portable assembly for extracting water from air according to an embodiment of the disclosure.

FIG. 2 is an isometric perspective view of an embodiment of the disclosure.

FIG. 3 is an exploded view of an embodiment of the disclosure.

FIG. 4 is an exploded view of an embodiment of the disclosure.

### DETAILED DESCRIPTION OF THE INVENTION

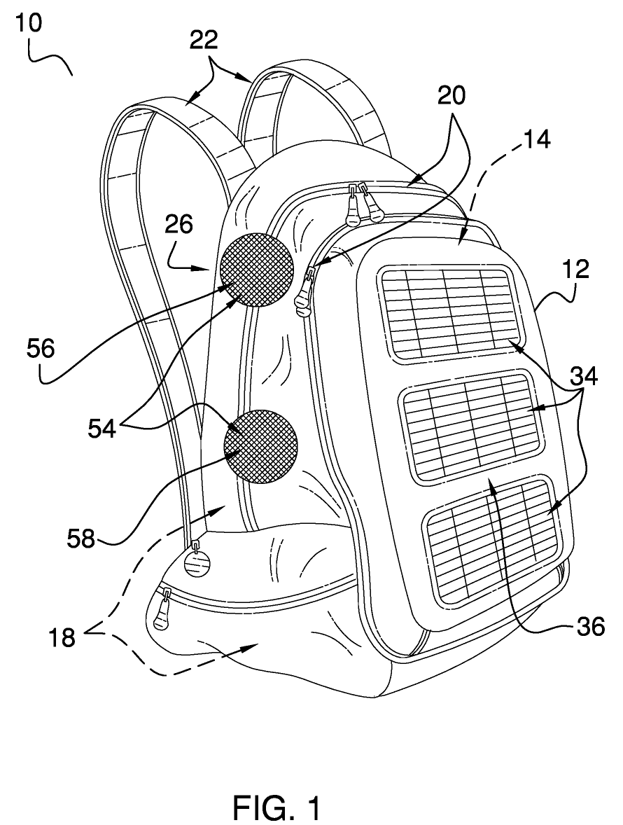

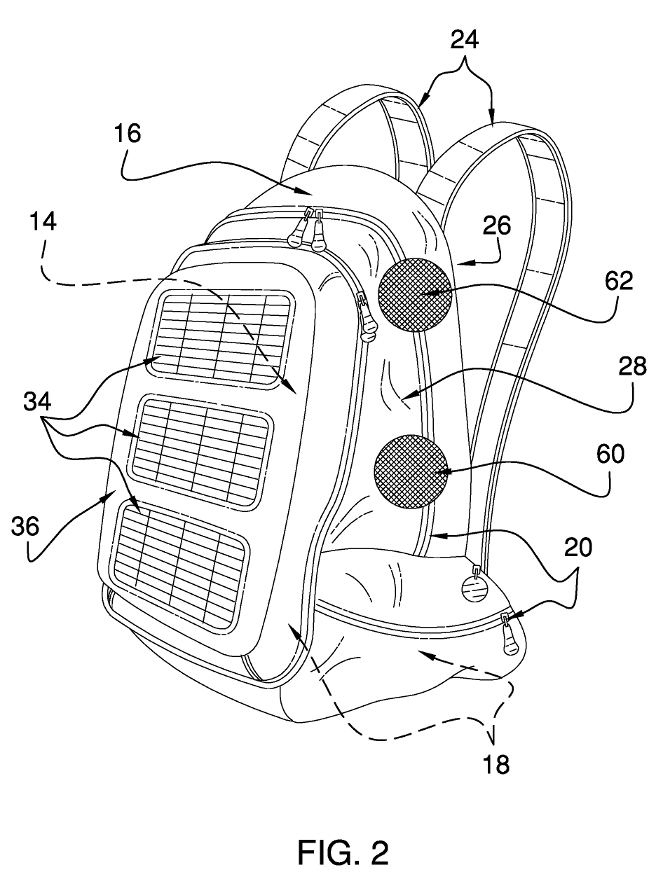

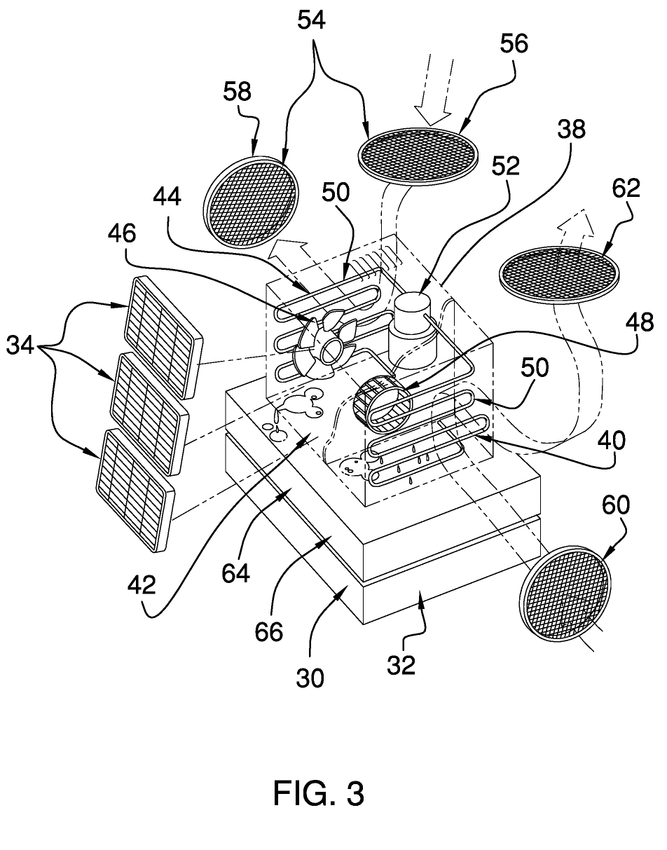

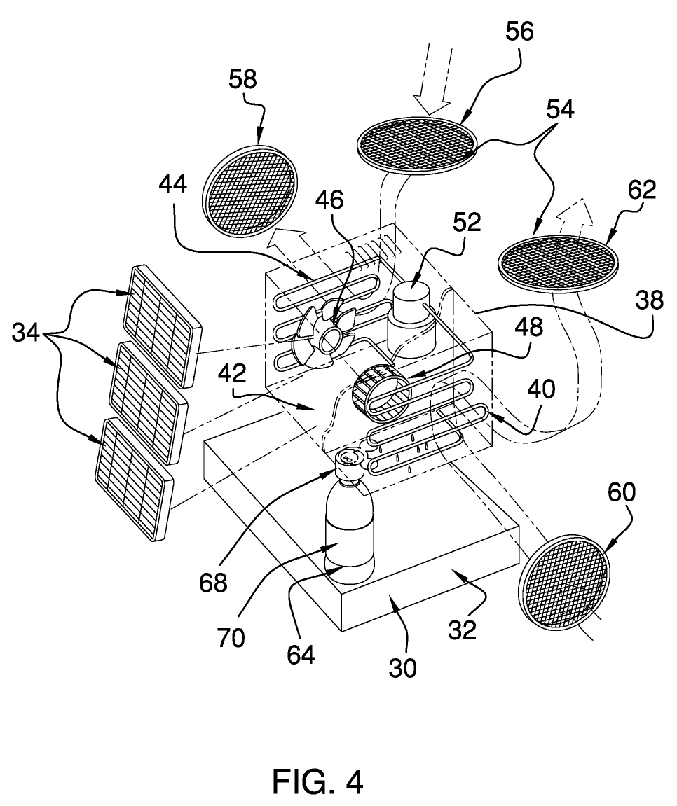

With reference now to the drawings, and in particular to FIGS. 1 through 4 thereof, a new water production assembly embodying the principles and concepts of an embodiment of the disclosure and generally designated by the reference numeral 10 will be described.

As best illustrated in FIGS. 1 through 4, the portable assembly for extracting water from air 10 generally comprises a housing 12 that defines an internal space 14. The housing 12 is vented. In one embodiment, the housing 12 comprises a shell 16. The shell 16 is flexible. In another embodiment, the internal space 14 comprises a plurality of compartments 18. Each of a plurality of zippers 20 is positioned in the housing 12 adjacent to an associated compartment 18. The zipper 20 is positioned on the housing 12 such that the zipper 20 is configured to open the associated compartment 18, wherein a user is positioned to access the associated compartment 18.

A plurality of grasps 22 is coupled to the housing 12. The grasps 22 are positioned on the housing 12 such that the grasps 22 are configured to couple to the user, wherein the housing 12 is coupled to the user for transport. In one embodiment, the grasps 22 comprise a pair of straps 24 that is coupled to a back 26 of the housing 12. Each strap 24 is positioned proximate to a respective opposing side 28 of the housing 12.

A power module 30 is coupled to the housing 12 and positioned in the internal space 14. In one embodiment, the power module 30 comprises at least one rechargeable battery 32.

A plurality of solar panels 34 is coupled to a front 36 of the housing 12. The solar panels 34 are operationally coupled to the power module 30. The solar panels 34 are positioned on the housing 12 such that the solar panels 34 are configured to convert solar energy into electric current. The electric current is directed to the power module 30 to charge the power module 30. In one embodiment, the plurality of solar panels 34 comprises three solar panels 34.

A condensing unit 38 is coupled to the housing 12 and positioned in the internal space 14. The condensing unit 38 is operationally coupled to the power module 30. The condensing unit 38 is positioned in the housing 12 such that an evaporator coil 40 of the condensing unit 38 is configured to contact air that enters the internal space 14. Water vapor in the air condenses on the evaporator coil 40 and falls to a bottom 42 of the condensing unit 38.

In one embodiment, the condensing unit 38 comprises the evaporator coil 40, a condenser coil 44, a fan 46, a blower 48, a refrigerant 50 and a compressor 52. The compressor 52 is operationally coupled to the power module 30. The evaporator coil 40 is operationally coupled to the compressor 52. The blower 48 is configured to draw air though the internal space 14 and across the evaporator coil 40. The condenser coil 44 is operationally coupled to the compressor 52. The fan 46 is configured to draw air though the internal space 14 and across the condenser coil 44 to cool the condenser coil 44. The refrigerant 50 is positioned in the condenser coil 44 and the evaporator coil 40. The compressor 52 is positioned to compress the refrigerant 50 such that the refrigerant 50 is liquefied. The evaporator coil 40 is positioned to receive the refrigerant 50, such that the refrigerant 50 evaporates and cools the evaporator coil 40. Water vapor in air that contacts the evaporator coil 40 is liquefied. The condenser coil 44 is positioned to receive the refrigerant 50 from the evaporator coil 40, such that the refrigerant 50 is cooled by air that passes over the condenser coil 44.

A plurality of vents 54 is positioned in the housing 12. The vents 54 are positioned in the housing 12 such that the vents 54 are configured to allow air to enter and exit the internal space 14. In one embodiment, the plurality of vents 54 comprises a first intake 56, a first exhaust 58, a second intake 60 and a second exhaust 62. The first intake 56 and the first exhaust 58 are positioned proximate to the condenser coil 44. The first exhaust 58 is positioned in the housing 12 such that air drawn by the fan 46 though the internal space 14 and across the condenser coil 44 exits the first exhaust 58. The second intake 60 and the second exhaust 62 are positioned proximate to the condenser coil 44. The second exhaust 62 is positioned in the housing 12 such that air drawn by the blower 48 though the internal space 14 and across the evaporator coil 40 exits the second exhaust 62.

A reservoir 64 is coupled to the housing 12 and positioned in the internal space 14 below the condensing unit 38. The reservoir 64 is fluidically coupled to the condensing unit 38. Liquid water positioned on the bottom 42 of the condensing unit 38 flows to and is collected in the reservoir 64. In one embodiment, the reservoir 64 comprises a bag 66. The bag 66 is flexible. The bag 66 comprises plastic.

In another embodiment of the invention, the assembly 10 comprises a purifier 68 that is coupled to the condensing unit 38. The purifier 68 is positioned on the condensing unit 38 such that liquid water produced by the condensing unit 38 is directed through the purifier 68. In this embodiment, the reservoir 64 comprises a bottle 70 that is reversibly couplable to the purifier 68. The bottle 70 is positioned on the purifier 68 such that liquid water passing through the purifier 68 is collected in the bottle 70.

In use, the grasps 22 are positioned on the housing 12 and are configured to couple to the user, such that the housing 12 is coupled to the user for transport. The condensing unit 38 is positioned in the housing 12 such that an evaporator coil 40 of the condensing unit 38 is configured to contact air that enters the internal space 14. Water vapor in the air condenses on the evaporator coil 40 and falls to the bottom 42 of the condensing unit 38. Liquid water that is positioned on the bottom 42 of the condensing unit 38 flows to and is collected in the reservoir 64.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable assembly for extracting water from air comprising:
a housing defining an internal space, said housing being vented;
a plurality of grasps coupled to said housing;
a power module coupled to said housing and positioned in said internal space;
a condensing unit coupled to said housing and positioned in said internal space, said condensing unit being operationally coupled to said power module;
a reservoir coupled to said housing and positioned in said internal space below said condensing unit, said reservoir being fluidically coupled to said condensing unit; and
wherein said grasps are positioned on said housing such that said grasps are configured for coupling to a user, such that said housing is coupled to the user for transport, wherein said condensing unit is positioned in said housing such that an evaporator coil of said condensing unit is configured to contact air entering said internal space, wherein water vapor in the air condenses on said evaporator coil and falls to a bottom of said condensing unit, such that liquid water positioned on said bottom of said condensing unit flows to and is collected in said reservoir.

2. The assembly of claim 1, further comprising:
said housing comprising a shell, said shell being flexible;
said internal space comprising a plurality of compartments;
a plurality of zippers, each said zipper being positioned in said housing adjacent to an associated said compartment, wherein said zipper is positioned on said housing such that said zipper is configured for opening said associated said compartment, such that a user is positioned to access said associated said compartment; and
said grasps comprising a pair of straps coupled to a back of said housing, each said strap being positioned proximate to a respective opposing side of said housing.

3. The assembly of claim 1, further including said power module comprising at least one rechargeable battery.

4. The assembly of claim 1, further including a plurality of solar panels coupled to a front of said housing, said solar panels being operationally coupled to said power module, wherein said solar panels are positioned on said housing such that said solar panels are configured to convert solar energy into electric current, such that the electric current is directed to said power module to charge said power module.

5. The assembly of claim 4, further including said plurality of solar panels comprising three said solar panels.

6. The assembly of claim 1, further including said condensing unit
comprising:
a compressor operationally coupled to said power module;
said evaporator coil being operationally coupled to said compressor;
a blower configured to draw air though said internal space across said evaporator coil;
a condenser coil operationally coupled to said compressor;
a fan configured to draw air though said internal space across said condenser coil, such that said condenser coil is cooled;
a refrigerant positioned in said condenser coil and said evaporator coil; and
wherein said compressor is positioned to compress said refrigerant such that said refrigerant is liquefied, wherein said evaporator coil is positioned to receive said refrigerant, such that said refrigerant evaporates and cools said evaporator coil, such that water vapor in air contacting said evaporator coil is liquefied, wherein said condenser coil is positioned to receive said refrigerant from said evaporator coil, such that said refrigerant is cooled by air passing over said condenser coil.

7. The assembly of claim 1, further including a plurality of vents positioned in said housing, wherein said vents are positioned in said housing such that said vents are configured for air to enter and exit said internal space.

8. The assembly of claim 6, further including a plurality of vents comprising:
a first intake positioned proximate to said condenser coil;
a first exhaust positioned proximate to said condenser coil, wherein said first exhaust is positioned in said housing such that air drawn by said fan though said internal space across said condenser coil exits said first exhaust;
a second intake positioned proximate to said positioned proximate to said condenser coil; and
a second exhaust positioned proximate to said evaporator coil, wherein said second exhaust is positioned in said housing such that air drawn by said blower though said internal space across said evaporator coil exits said second exhaust.

9. The assembly of claim 1, further including said reservoir comprising a bag, said bag being flexible, said bag comprising plastic.

10. The assembly of claim 1, further comprising:
a purifier coupled to said condensing unit, wherein said purifier is positioned on said condensing unit such that liquid water produced by said condensing unit is directed through said purifier; and
said reservoir comprising a bottle reversibly couplable to said purifier, wherein said bottle is positioned on said purifier such that liquid water passing through said purifier is collected in said bottle.

11. A portable assembly for extracting water from air comprising:
a housing defining an internal space, said housing being vented, said housing comprising a shell, said shell being flexible, said internal space comprising a plurality of compartments;
a plurality of zippers, each said zipper being positioned in said housing adjacent to an associated said compartment, wherein said zipper is positioned on said housing such that said zipper is configured for opening said associated said compartment, such that a user is positioned to access said associated said compartment;
a plurality of grasps coupled to said housing, wherein said grasps are positioned on said housing such that said grasps are configured for coupling to a user, such that said housing is coupled to the user for transport, said grasps comprising a pair of straps coupled to a back of said housing, each said strap being positioned proximate to a respective opposing side of said housing;
a power module coupled to said housing and positioned in said internal space, said power module comprising at least one rechargeable battery;
a plurality of solar panels coupled to a front of said housing, said solar panels being operationally coupled to said power module, wherein said solar panels are positioned on said housing such that said solar panels are configured to convert solar energy into electric current, such that the electric current is directed to said power module to charge said power module, said plurality of solar panels comprising three said solar panels;
a condensing unit coupled to said housing and positioned in said internal space, said condensing unit being operationally coupled to said power module, wherein said condensing unit is positioned in said housing such that an evaporator coil of said condensing unit is configured to contact air entering said internal space, wherein water vapor in the air condenses on said evaporator coil and falls to a bottom of said condensing unit, said condensing unit comprising:
a compressor operationally coupled to said power module,
said evaporator coil being operationally coupled to said compressor,
a blower configured to draw air though said internal space across said evaporator coil,
a condenser coil operationally coupled to said compressor,
a fan configured to draw air though said internal space across said condenser coil, such that said condenser coil is cooled,
a refrigerant positioned in said condenser coil and said evaporator coil, and
wherein said compressor is positioned to compress said refrigerant such that said refrigerant is liquefied, wherein said evaporator coil is positioned to receive said refrigerant, such that said refrigerant evaporates and cools said evaporator coil, such that water vapor in air contacting said evaporator coil is liquefied, wherein said condenser coil is positioned to receive said refrigerant from said evaporator coil, such that said refrigerant is cooled by air passing over said condenser coil;
a plurality of vents positioned in said housing, wherein said vents are positioned in said housing such that said vents are configured for air to enter and exit said internal space, said plurality of vents comprising:
a first intake positioned proximate to said condenser coil,
a first exhaust positioned proximate to said condenser coil, wherein said
first exhaust is positioned in said housing such that air drawn by said fan though said internal space across said condenser coil exits said first exhaust,
a second intake positioned proximate to said positioned proximate to said condenser coil, and
a second exhaust positioned proximate to said evaporator coil, wherein said second exhaust is positioned in said housing such that air drawn by said blower though said internal space across said evaporator coil exits said second exhaust;
a reservoir coupled to said housing and positioned in said internal space below said condensing unit, said reservoir being fluidically coupled to said condensing unit, such that liquid water positioned on said bottom of said condensing unit flows to and is collected in said reservoir, said reservoir comprising a bag, said bag being flexible, said bag comprising plastic; and
wherein said grasps are positioned on said housing such that said grasps are configured for coupling to a user, such that said housing is coupled to the user for transport, wherein said condensing unit is positioned in said housing such that an evaporator coil of said condensing unit is configured to contact air entering said internal space, wherein water vapor in the air condenses on said evaporator coil and falls to a bottom of said condensing unit, such that liquid water positioned on said bottom of said condensing unit flows to and is collected in said reservoir.

12. The assembly of claim 11, further comprising:
a purifier coupled to said condensing unit, wherein said purifier is positioned on said condensing unit such that liquid water produced by said condensing unit is directed through said purifier; and
said reservoir comprising a bottle reversibly couplable to said purifier, wherein said bottle is positioned on said purifier such that liquid water passing through said purifier is collected in said bottle.
